(19) United States
(12) Patent Application Publication
(10) Pub. No.: US 2026/0241733 A1
(43) Pub. Date: Aug. 20, 2026

(54) METHOD AND SYSTEM FOR APPLYING A REVEAL FILM TO A GREETING CARD

(71) Applicant: Hallmark Cards, Incorporated, Kansas City, MO (US)

(72) Inventors: Dennis Allan Evans, Kansas City, MO (US); Jasmine Mae Al-Hussain, Lenexa, KS (US); Eugene Albert Petrie, McLouth, KS (US); Megan Tara Palombo, Kansas City, MO (US)

(21) Appl. No.: 19/182,094

(22) Filed: Apr. 17, 2025

Related U.S. Application Data
(60) Provisional application No. 63/779,768, filed on Mar. 28, 2025.
(60) Provisional application No. 63/759,939, filed on Feb. 18, 2025.

(51) Int. Cl. B41M 3/00; B41M 1/04; B41M 7/00; G09F 1/00

(52) U.S. Cl. CPC B41M 3/005; B41M 1/04; B41M 3/008; B41M 7/0045; G09F 1/00

(57) ABSTRACT

A printing process comprises printing a mark on a surface of uncoated paper stock, applying a release coating over the mark, subjecting the release coating to a first ultra- violet drying process, applying a first scratch-off layer of coating over the layer of release coating, subjecting the first scratch-off layer to a second ultra-violet drying process, applying a second scratch-off layer of coating over the first scratch-off layer, and subjecting the second scratch-off layer to a third ultra-violet drying process.

### CROSS-REFERENCE TO RELATED APPLICATIONS

This Application claims the benefit of priority of (1) U.S. Provisional Application 63/779,768 (entitled “METHOD AND SYSTEM FOR APPLYING A REVEAL FILM TO A GREETING CARD” and filed on 03/28/2025) and (2) U.S. Provisional Application 63/759,939 (entitled “METHOD AND SYSTEM FOR APPLYING A REVEAL FILM TO A GREETING CARD” and filed on 02/18/2025), both of which are incorporated by reference herein.

This Application also incorporates by reference U.S. Application 18/780,779 (entitled “GREETING CARD WITH ACTIONABLE APERTURE” and filed on 07/23/2024) and U.S. Patent No. 12,086,868, including all the patents and applications that it references directly or indirectly.

### BACKGROUND

Greeting cards offer a way to create or deepen connections with others. They can also be used to retrieve or convey a digital asset such as a digital complement or item of value. U.S. Application 18/780,779, which is incorporated by reference herein, explains this in greater detail. As an example, a QR code can be included as part of a greeting card. The QR code can be used by the sender to set or identify the digital asset. Afterwards, the QR code is useable by the recipient to retrieve the digital asset, which, as mentioned, could be a link to a monetary value to, for example, receive a gifted dollar.

But bad actors may attempt to fraudulently obtain the digital asset. For example, they could attempt to intercept the digital asset after the sender has associated it with the QR code. One way of guarding against this is to ensure that the person attempting to retrieve the digital asset is the intended recipient, which can be ensured by confirming that the person is in physical possession of the card. One way to help make sure that the person trying to retrieve the digital asset possesses the card is to receive an identifier or code that is printed on the card and is associated with the card, QR code, or both.

The unique identifier, however, should not be visible before purchase (or at least before the sender has associated the card with a desired digital asset. Thus, the unique identifier should be initially covered. And therein lies the problem. Absent the present invention, covering the unique identifier on a greeting card with a film that covers the unique identifier, is opaque, sticks to the greeting card, will not come off absent an intentional action such as scratching, but does come of well when subject to scratching cannot be accomplished as later disclosed herein. Many problems of covering a unique identifier on a greeting card stem from the greeting card being uncoated (variously referred to as uncovered, plain, or matte finished). This is different from a glossy substrate such as a shiny piece of packaging.

By way of any example, screen printing and foil stamping are not suitable. Historically, attempts have been made to use a screen-print or foil-stamping process to apply scratch-off film. But not onto paper and not when a large substrate is desired to be printed on. For example, if one wanted to apply the type of film disclosed herein on a substrate that is forty inches wide (and/or long), that would not be possible because such large screen-print machines are not available or are not capable of applying the film described herein with the desired outcomes. For example, other techniques, such as hot-stamping, would lead to an undesired embossing type of effect on a card whereby a portion is raised that is not desired to be raised. This can stem from applying pressure to a side of a card with a raised film, resulting in a raised portion on the opposite side—a sort of undesirable bump on an otherwise aesthetically pleasing greeting card. Also, some techniques might attempt to achieve the results disclosed herein, but with multiple passes through multiple machines, unfavorably increasing work to an infeasible amount.

Alternative techniques also become impractical when there is a desire to do multiple cards at a time from a large substrate (mentioned above). For example, production techniques often require printing multiple copies of a card simultaneously by first printing multiple instances on a large, uncut sheet. Then, after printing, the individual cards are cut from the large sheet. Printing each small card would not be feasible.

Still another barrier to a feasible solution is the nature of the desired substrate: paper stock. Although films may have been able to be applied to rigid plastic substrates, the process used to apply a film to plastic is not useable to apply the film described herein to uncoated paper stock.

A need exists to provide a suitable film and application technique to apply a removable, opaque security film onto an ornate greeting card that can also be well moved by a scratching action to disclose any type of concealed information.

### BRIEF DESCRIPTION OF THE DRAWINGS

FIG. 1 depicts an illustrative substrate (such as a greeting card) suitable for practicing an embodiment of the disclosed technology, showing a unique identifier revealed.

FIG. 2A depicts a greeting card showing a unique identifier obscured by an opaque film in accordance with an embodiment of the disclosed technology.

FIG. 2B depicts a greeting card showing a zoomed-in section of the opaque film in accordance with an embodiment of the disclosed technology.

FIG. 2C is a close-up view of the opaque film in accordance with an embodiment of the disclosed technology.

FIG. 3A depicts an illustrative system and method for applying a film in accordance with an embodiment of the disclosed technology.

FIG. 3B depicts an illustrative substrate showing multiple greeting cards in accordance with an embodiment of the disclosed technology.

### DETAILED DESCRIPTION

The subject matter of the present disclosure is described with specificity herein to meet statutory requirements. However, the description itself is not intended to limit the scope of this patent. Rather, the claimed subject matter is contemplated to also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

One aspect of the technology described herein provides an opaque film and application technique to apply a removable, opaque security film onto an ornate greeting card that is also removable by a scratching action to disclose concealed information. The concealed information need not be confidential or secure information. It can be, but need not be. In other embodiments, the concealed information can be a hidden message, another code, anything else that is desired to initially be obscured from a user.

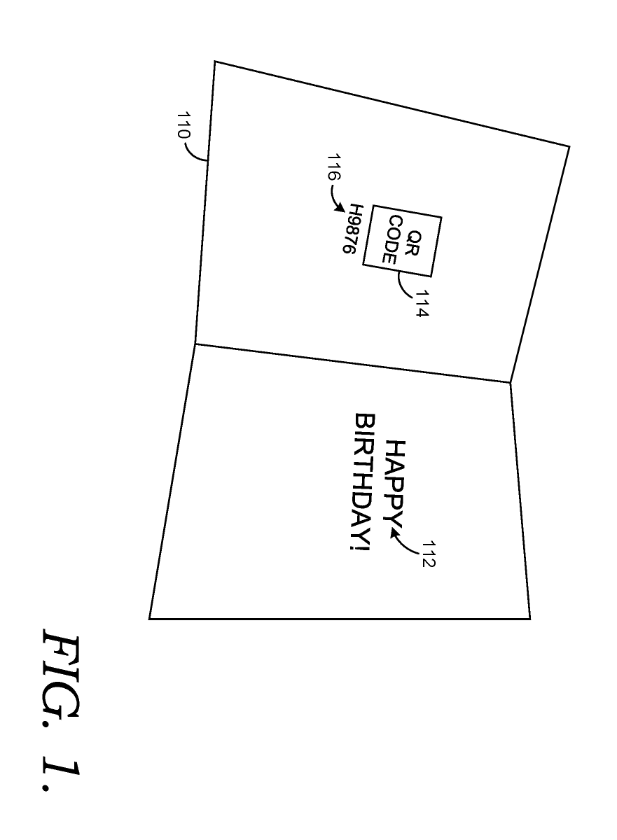

FIG. 1 depicts an illustrative substrate (such as a greeting card 110) suitable for practicing an embodiment of the disclosed technology. In this embodiment, the substrate is paper. Greeting card 110 can include a message 112 such as “Happy Birthday!” It can also include a QR code (or other identifier) 114 that, in some embodiments, links to a digital asset as described in greater detail in U.S. Application No. 18/780,779 and U.S. Patent No. 12,086,868, both of which are incorporated by reference herein. Including QR code 114 is not necessary.

Card 110 also includes a mark 116, also referred to herein as concealed information 116. It can take on a variety of forms. In FIG. 1, and for illustrative and explanatory purposes, mark 116 is visible. It can be a unique identifier (such as “H9876,” “1234,” or similar) that is associated with card 110, QR code 114, or both. In some embodiments, mark 110 helps prevent fraud by providing a way to identify card 110 or otherwise confirm that a holder is in possession of it. Mark 116 can be a string of numeric digits, alpha-numeric characters, another QR code, a URL, a fun phrase, an image, a hidden message, and the like. It can be anything that is desired to be at least initially hidden from an observer. In one embodiment, mark 116 is a numerical PIN, such as a string or four or five numbers.

In one embodiment, mark 116 is printed directly on card 110. For example, it can be printed via ink, laser printed, copied onto, lithographically applied, or otherwise printed directly on card 110.

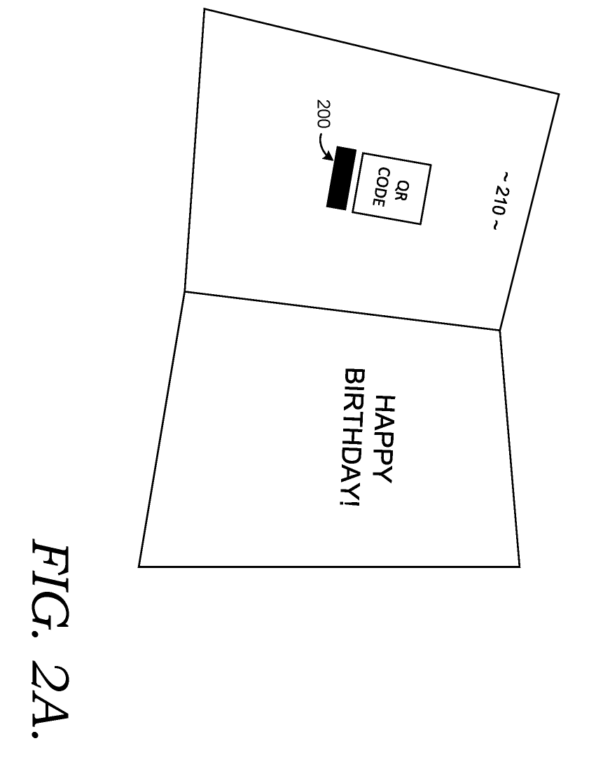

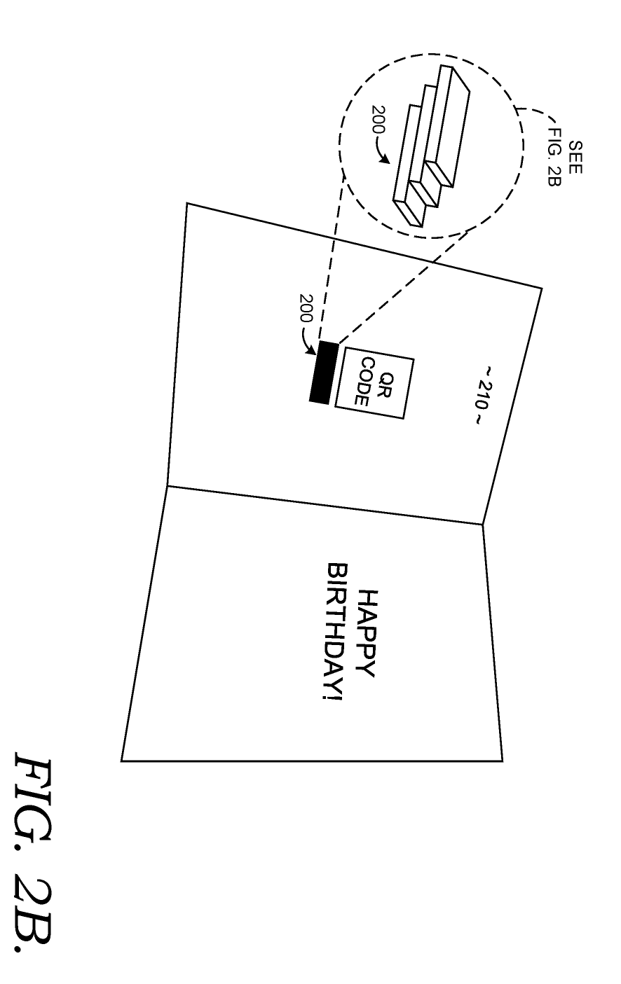

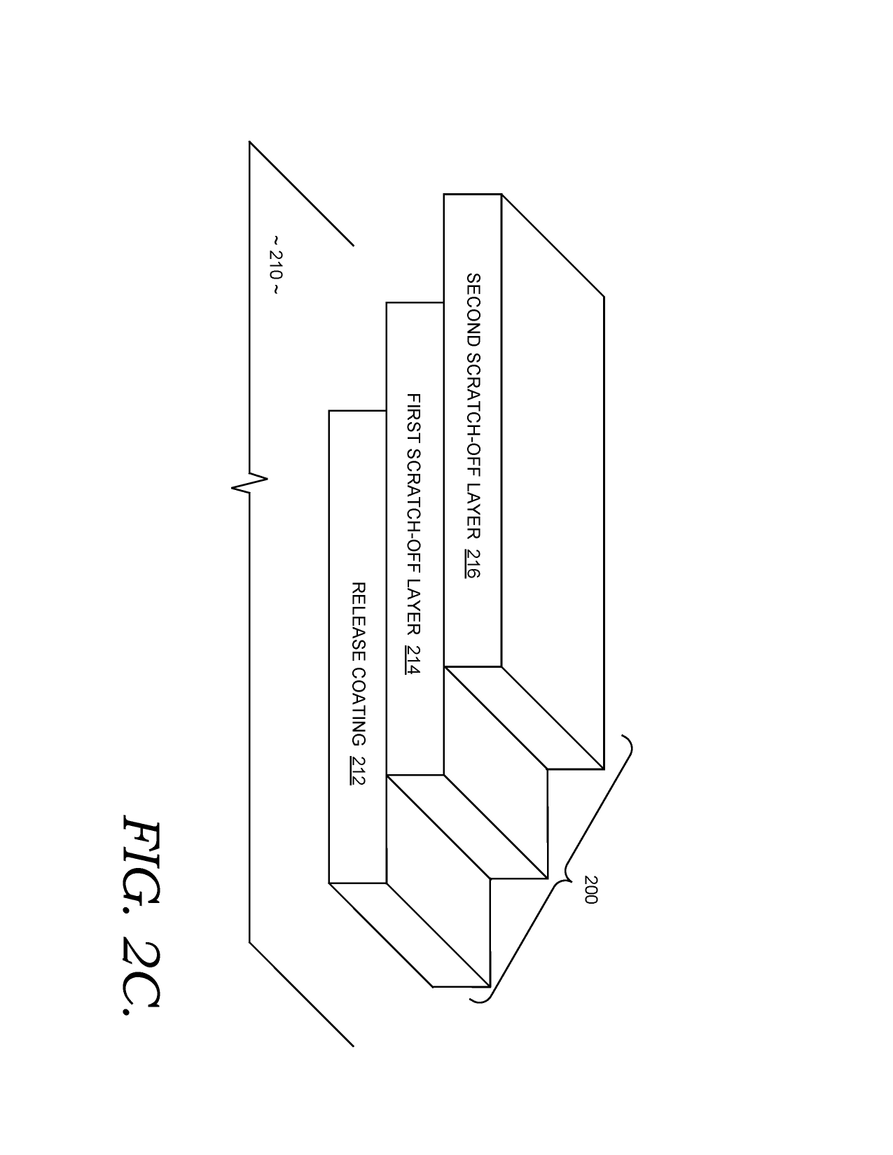

FIG. 2A shows a card (like in FIG. 1) with the concealed information obscured by film 200. Film 200 is opaque. It hides the information below it. A person cannot see through film 200. It is shown as applied to surface 210 of a greeting card in one embodiment. Surface 210 could be any of the four surfaces of the card of FIG. 2A.

FIG. 2B shows that film 200 has depth and is composed of multiple layers. The call-out (shown in broken lines) shows a zoomed in view of film 200 that is greatly exaggerated purely for the purpose of being able to discuss aspects of it herein. It is not to scale. The makeup of film 200 is described in words herein.

FIG. 2C shows a still more blown-up image of film 200 atop surface 210. Film 200 includes a release layer 212, a first scratch-off layer (or “reveal”) 214, and a second scratch-off (or “reveal”) layer 216 in one embodiment.

In one embodiment, release coating 212 has a volume between about 3 to 9 BCM (billion cubic microns) per square inch. The release coating can be silicon-based in one embodiment. In some embodiments, release coating 212 is applied with a volume of about 7 BCM per square inch and a striping metric of about five millimeters wide. Here, “striping” refers to the width of an application that stems from the pressure between anilox roll and a cylinder plate. Applying more pressure between the anilox roll and cylinder plate will increase the striping width. Here, the presume between the two, in one embodiment, is desired to be such that striping is between about four and six millimeters, and preferably five.

In one embodiment, first scratch-off layer 214 has a volume between about 8 to 12 BCM per square inch. The application pressure is such that striping would be between about 4 and 6 millimeters wide, with a preference for 5. In some embodiments, first scratch-off layer 214 has a volume of about 10 BCM per square inch. The application layer has properties similar to those of a latex in some embodiments and includes chrome flakes, which help achieve desired opacity.

In one embodiment, second scratch-off layer 216 has a volume between about 10 to 14 BCM per square inch applied with pressure to generate a striping characteristic of between about 3 to 9 millimeters wide, preferably 5 to 7. In some embodiments, second scratch-off layer 214 has a volume of about 12 BCM per square inch. The final volume could be increased if desired, including substantially if additional UV lamps are employed to sufficiently dry the final application.

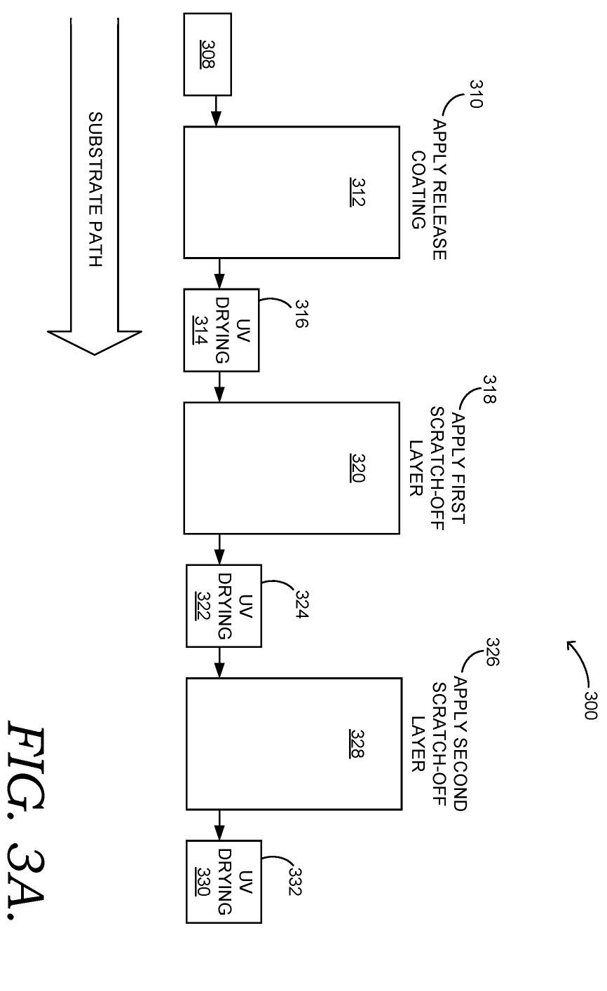

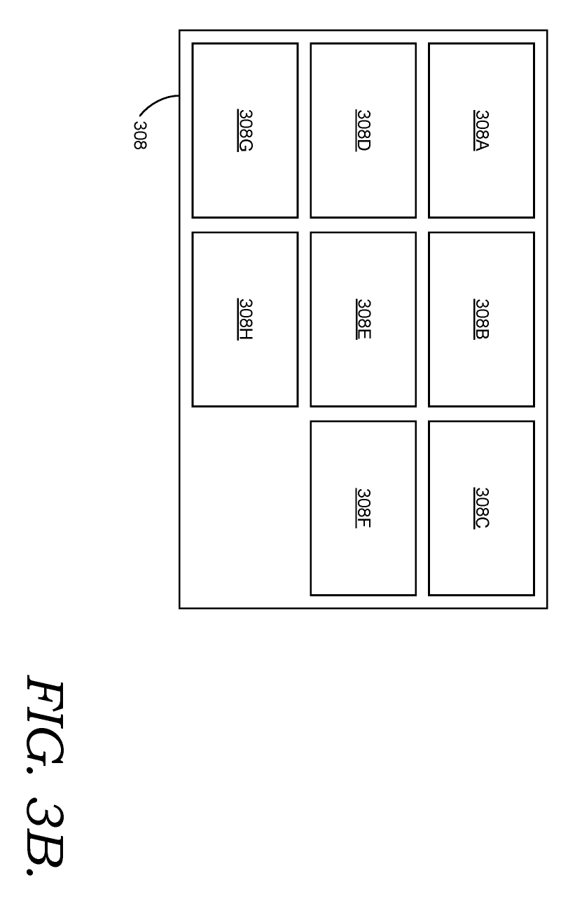

Turning now to FIG. 3A, an illustrative operating environment 300 depicts a process suitable for practicing aspects of the disclosed technology. Although various blocks are shown, those should not be understood to correspond to different physical machines or apparatuses. They are so shown and numbered purely to help explain certain functional aspects. Some functional aspects might be part of common devices or vice versa. In some embodiments, all functional aspects might be present in a single machine or apparatus.

In one embodiment, the process enables the application of film 200 on a substrate 308 that complies with prescribed security protocols. The process preserves the greeting cards’ mechanical integrity and aesthetic appeal.

FIG. 3A includes a large arrow indicating that in the one example shown, the substrate 308 flows from left to right. In one embodiment, substrate 308 is paper. Paper can include card stock, variously referred to as paper stock, or just “paper.” As shown in FIG. 3B, substrate 308 could be a large sheet of paper, such as having one side be on the order of 40 inches, thereby useable to print multiple cards (308A-H) simultaneously.

In one embodiment, three flexo chamber printing units (312, 320, 328) are included. These can include inter deck UV (ultraviolet) lamps. Drying processes via UV lamps are shown as numerals 314, 322, 330. UV lamps 314, 322, and 330 can be 1000-watt UV lamps for example. Additional lamps beyond 332 could be employed to dry thicker final-coat layers.

In one embodiment, the process of FIG. 3A does not include either a screen-print process or a foil-stamp process. In one embodiment, a top-reverse technique is employed.

In one embodiment, substate 308 enters unit 312, where release coat 212 is applied. Unit 312 uses an anilox roll to apply release coat 212 at a volume of about 7 BCM per square inch. Release coat 212 is dried further at a step 316. That drying process 316 employs a UV-drying process, such as by using UV lamps in unit 314. In one embodiment, the drying process is cured without contact with any other wet ink or coating layers. “Drying” and “curing” are used interchangeably herein to connote a common concept.

Next, substrate 308 is fed into unit 320, in one embodiment, or otherwise has first scratch-off layer 214 applied. Unit 320 utilizes an anilox roll to apply first reveal layer 214 at a volume of about 14 BCM per square inch, though that number can vary, as explained above. First reveal layer 214 is cured by a UV drying/curing process at a step 324. UV lamps of a unit 322 can be used. It utilizes a dry-trap situation like the release layer in one embodiment, where the coating 214 is cured in isolation without interacting with any other wet layers.

In one embodiment, a final application occurs at a step 326, where a second reveal layer 216 is applied. This can occur via until 328 in one embodiment, which can include an anilox roll that applies a volume of about 10 BCM per square inch. It is a known challenge for two UV coatings to overprint effectively, especially when dealing with two specialized coatings loaded with a dynamic opaque ink. After the initial release coating 212 is printed, it is subjected to the UV curing unit 314 for curing. Subsequently, the first reveal coating 214 follows the same path, being subjected to curing in UV unit 322. Each layer is processed in a dry trap condition, helping to ensuring that they cure independently without interaction.

In some embodiments, a relatively softer durometer “Shore A” flexo plate (flexographic printing plate) is used. “Shore A” hardness is on scale ranging from 0 to 100, where a lower value indicates a softer material. A higher value indicates a harder material. Here, Shore A can indicates a hardness metric of flexo plates. A common range of hardness is, for example, from 20 to 80 Shore A. The disclosed technology can use a relatively softer surface plate material to reach desired effects. In flexographic printing, the surface hardness can influence the amount or volume of material that can transfer. In one embodiment the Shore A hardness of the plates is about 72. Additionally or alternatively, the Shore A hardness is greater than 68 in some embodiments.

Photopolymer plate materials are used as an agent on a press to transfer printing ink/coating to a substrate/paper. Photopolymer plates come in different levels of hardness for specific applications. “Packing” refers to material placed behind the plate to act as a spacer and shock absorber on a flexographic press. Packing can range from open cell foam to paper, based on the specific need and application.

The wide array of plate material and packing options preclude simply selecting one available option, for example. Here, a variety of anilox rolls were tested in various combinations. Anilox rolls can be measured in BCM’s (billions of cubic microns), a unit used to measure the volume of ink in flexographic printing. It can also be used to measure the cell volume of anilox rollers. Anilox rolls can be, for example, 7, 10, 12, 14, 20, or 38 BCMs. Here, testing was conducted using across three print stations, including rotating the rollers in three print stations to evaluate what combination yielded the best results. It was determined that optimized performance and production in one embodiment was one unit with 7 BCM roller (release coat), a second unit with a 10 BCM roller (first scratch-off-coating layer), and a third unit with a 12 BCM roller (second -off-coating layer).

In printing, a screened percentage of a coating or ink over one another may net a better result in opacity than printing two solids. This is due to many reasons, such as tack, trap, flow, surface tension ink compatibility etc. Different screen percentages were evaluated to try to increase the opacity of the ultimate scratch-off coating to meet desired specifications. In some instances, “1 hit” was used of a screen and then a solid. Other times, “2 hits” of a screen were used.

Other tests demonstrated lack of desired results. For example, a Komori press was evaluated. It uses a litho print unit at the front of the press. Attempts were made to apply the release coating with the litho print station to see if sufficient opacity could be achieved. But this was found to not be satisfactory.

Efforts were made to reach a desired opacity. Noise was added in the photopolymer printing plate to try sufficiently obscure the PIN (under the scratch-off coating). The noise could be, for example, a series of “###” and $$$”, to mask and confuse the standard observer trying to cheat looking through the scratch off coating. Ultimately, opacity levels were actually achieved through material changes and testing, including, in one embodiment, using a solid block in all three units.

Card stock 308 can flow through the process at certain press speeds. An illustrative press speed suitable for practicing an embodiment of the technology is 5500 sheets per hour. Speeds could be reduced or increased substantially depending on desired outcomes, such as from 2750 two 18000 sheets per hour.

In some embodiments, the reveal coatings 216 or 214 can be color tinted. This can help tailor the card to the situation or context. For example, red or green colors might be popular for a Christmas Card. Or orange or black might be used for Halloween cards.

One embodiment of the disclosed technology includes film-application process. An embodiment of the printing process includes printing a mark on a surface of uncoated paper card stock, applying a release coating over the mark, wherein the release coating covers a first area of the card stock, subjecting the release coating to a first ultra-violet drying process, applying a first scratch-off layer of coating over the layer of release coating, subjecting the first scratch-off layer to a second ultra-violet drying process, applying a second scratch-off layer of coating over the first scratch-off layer, subjecting the second scratch-off layer to a third ultra-violet drying process, wherein the mark is not visible after the third ultra-violet drying process.

Another embodiment includes applying an opaque film to uncoated paper, wherein the opaque film obscures a mark underneath it such that the mark is not visible through the film, wherein the film includes a release coating over the mark, a first scratch-off layer over the release coating, and a second scratch-off layer over the first scratch off layer, wherein each of the first and second scratch-off layers includes chrome flakes, and wherein the applying includes drying the release coating by an ultraviolet drying process before applying the first scratch-off layer, drying the first scratch-off coating by an ultraviolet drying process before applying the second scratch-off layer, and drying the second scratch-off coating by an ultraviolet drying process.

Another embodiment of the disclosed technology takes the form of a greeting card that includes a marking printed thereon, wherein the marking is printed on an uncoated paper product. It further includes an opaque film obscuring the marking from view, wherein the film includes a release layer applied to the greeting card over the marking, a first scratch-off layer covering the release layer, and a second scratch-off layer covering the first release layer, wherein the first and second scratch-off layers are indistinguishable from each other and both include chrome flakes.

This application claims the benefit of or incorporates other patent applications by reference. If there are ambiguities or conflicts between them, the more recently filed applications should be construed to clarify or preempt perceived differences.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility, may be employed without reference to other features and sub combinations, and are contemplated within the scope of the claims.

What is claimed is:

1. A film-application process, comprising:
printing a mark on a surface of a portion of uncoated paper stock;
applying a release coating over the mark, wherein the release coating covers a first area of the paper stock;
subjecting the release coating to a first ultra-violet drying process;
applying a first scratch-off layer of coating over the release coating;
subjecting the first scratch-off layer to a second ultra-violet drying process;
applying a second scratch-off layer of coating over the first scratch-off layer;
subjecting the second scratch-off layer to a third ultra-violet drying process, wherein the mark is not visible after the third ultra-violet drying process.

2. The process of claim 1, wherein at least one (1) applying the release coating, (2) applying the first scratch-off layer, and (3) applying a second scratch-off layer is performed utilizing a flexographic printing plate with a hardness in a range of about 69 to 74.

3. The process of claim 1, wherein the mark is ink printed or laser printed on the surface of the paper stock and wherein the paper stock includes a plurality of individual greeting cards.

4. The process of claim 3, wherein the mark includes an identifier that is useable to identify either (1) a first greeting card from among the plurality of greeting cards or (2) an item associated with the first greeting card.

5. The process of claim 1, wherein the release coating has a volume between about 6 to 8 BCM (billion cubic microns) per square inch.

6. The process of claim 5, wherein the release coating has a volume of about 7 BCM (billion cubic microns) per square inch.

7. The process of claim 1, wherein the first scratch-off layer has a volume between about 9 to 11 BCM (billion cubic microns) per square inch.

8. The process of claim 7, wherein the first scratch-off layer has a volume of about 10 BCM (billion cubic microns) per square inch.

9. The process of claim 1, wherein the second scratch-off layer has a volume between about 10 to 14 BCM (billion cubic microns) per square inch.

10. The process of claim 9, wherein the second scratch-off layer has a volume of about 12 BCM (billion cubic microns) per square inch.

11. The process of claim 1, wherein a composition of the first and second scratch-off layers includes chrome flakes.

12. The process of claim 1 wherein the process is not performed by a screen-printing process or foil-stamping process.

13. The process of claim 1 wherein the process occurs at a rate between about 4000 and 7000 sheets per hour.

14. A product printed by the process of claim 1.

15. A printing process, comprising:
applying an opaque film to uncoated paper,
wherein the opaque film obscures a mark underneath it such that the mark is not visible through the film,
wherein the film includes a release coating over the mark, a first scratch-off layer over the release coating, and a second scratch-off layer over the first scratch off layer,
wherein each of the first and second scratch-off layers includes chrome flakes, and
wherein the applying includes drying the release coating by an ultraviolet drying process before applying the first scratch-off layer, drying the first scratch-off layer by an ultraviolet drying process before applying the second scratch-off layer, and drying the second scratch-off layer by an ultraviolet drying process.

16. The printing process of claim 15, wherein opaque film includes chrome flakes.

17. The printing process of claim 16, wherein the release coating has a volume of about seven BCM/square inch, the first scratch-off layer has a volume of about ten BCM/square inch, and the second scratch-off layer has a volume of about twelve BCM/square inch.

18. The printing process of claim 17, wherein the applying the film at a rate of at least about 2000 sheets per hour.

19. A greeting card produced by the process of claim 15.

20. A greeting card, comprising:
a marking printed thereon, wherein the marking is printed on an uncoated paper product;
an opaque film obscuring the marking from view, wherein the film includes a release layer applied to the greeting card over the marking, a first scratch-off layer covering the release layer, and a second scratch-off layer covering first release layer, wherein the first and second scratch-off layers are indistinguishable from each other and both include chrome flakes.
